(19) United States
(12) Patent Application Publication
(10) Pub. No.: US 2025/0232407 A1
(43) Pub. Date: Jul. 17, 2025

(54) DISPLAY SYSTEM AND DISPLAY METHOD

(71) Applicants: Komatsu Ltd., Tokyp (JP); TOKYO INSTITUTE OF TECHNOLOGY, Tokyo (JP)

(72) Inventors: Masamitsu Kitahashi, Tokyo (JP); Masayuki Tanaka, Tokyo (JP); Masatoshi Okutomi, Tokyo (JP); Ayaha Tanihata, Tokyo (JP)

(73) Assignees: Komatsu Ltd., Tokyp (JP); TOKYO INSTITUTE OF TECHNOLOGY, Tokyo (JP)

(21) Appl. No.: 18/700,294

(22) PCT Filed: Nov. 9, 2022
(86) PCT No.: PCT/JP2022/041689

§ 371 Date: Apr. 8, 2025

(30) Foreign Application Priority Data
Nov. 15, 2021 (JP) 2021-185500

(51) Int. Cl. G06T 5/50

(52) U.S. Cl. CPC G06T 5/50; G06T 2207/30252

(57) ABSTRACT

A display system includes: a first transformation unit that generates a plurality of first transformation images from a first image obtained by imaging by a first imaging device; a first synthesis unit that combines a second image obtained by imaging by a second imaging device and each of a plurality of the first transformation images to generate a plurality of first composite images; a selection unit that selects a certain first composite image from the plurality of first composite images; and a display control unit that causes a display device to display a display image generated on the basis of the first composite image that has been selected.

### FIELD

The present disclosure relates to a display system and a display method.

### BACKGROUND

There is known an image synthesis system as disclosed in Patent Literature 1. There is known an image synthesis method as disclosed in Non Patent Literature 1.

### CITATION LIST

### Patent Literature

Patent Literature 1: JP 2016-032289 A

### Non Patent Literature

Non Patent Literature 1: T. Shibata, M. Tanaka and M. Okutomi, “Gradient-Domain Image Reconstruction Framework with Intensity-Range and Base-Structure Constraints,” 2016 IEEE Conference on Computer Vision and Pattern Recognition (CVPR), Las Vegas, NV, 2016, pp. 2745-2753, doi: 10.1109/CVPR.2016.300.

### SUMMARY

### Technical Problem

In a technical field related to work machines, there is known technology for capturing images of surroundings of a work machine by a visible light imaging device and an infrared light imaging device, combining a visible light image and an infrared light image, and providing the combined image to an operator of the work machine. By confirming the composite image of the visible light image and the infrared light image, the operator can confirm the situation around the work machine even at night or in a backlight state. Meanwhile, with the visible light imaging device and the infrared light imaging device installed at a distance physically, the composite image of the visible light image and the infrared light image may have a shift in the image due to parallax, which may make the image unclear.

An object of the present disclosure is to provide an operator of a work machine with a situation around the work machine even when an event of an unclear composite image occurs.

### Solution to Problem

In order to achieve an aspect of the present invention, a display system comprises: a first transformation unit that generates a plurality of first transformation images from a first image obtained by imaging by a first imaging device; a first synthesis unit that combines a second image obtained by imaging by a second imaging device and each of a plurality of the first transformation images to generate a plurality of first composite images; a selection unit that selects a certain first composite image from the plurality of first composite images; and a display control unit that causes a display device to display a display image generated on a basis of the first composite image that has been selected.

### Advantageous Effects of Invention

According to the present disclosure, it is possible to provide the operator of the work machine with the situation around the work machine even when an event of an unclear composite image occurs.

### BRIEF DESCRIPTION OF DRAWINGS

FIG. 1 is a diagram schematically illustrating a remote operation system of a work machine according to an embodiment.

FIG. 2 is a perspective view illustrating the work machine according to the embodiment.

FIG. 3 is a perspective view illustrating a visible light imaging device and a far-infrared imaging device according to the embodiment.

FIG. 4 is a diagram schematically illustrating a visible light imaging device according to the embodiment.

FIG. 5 is a functional block diagram illustrating a remote operation system of the work machine according to the embodiment.

FIG. 6 is a diagram schematically illustrating an example of a state in which the visible light imaging device according to the embodiment is capturing an image of an imaging target.

FIG. 7 is a diagram schematically illustrating an example of a state in which the infrared imaging device according to the embodiment is capturing an image of the imaging target.

FIG. 8 is a diagram schematically illustrating an outline of processing of an image processing unit according to the embodiment.

FIG. 9 is a diagram for explaining an influence of parallax between the visible light imaging device and the infrared imaging device on processing of the image processing unit.

FIG. 10 is a functional block diagram illustrating an image processing unit according to the embodiment.

FIG. 11 is a functional block diagram illustrating an alignment processing unit according to the embodiment.

FIG. 12 is a diagram schematically illustrating an outline of processing of the alignment processing unit according to the embodiment.

FIG. 13 is a flowchart illustrating a display method according to the embodiment.

FIG. 14 is a block diagram illustrating a computer system according to the embodiment.

### DESCRIPTION OF EMBODIMENTS

Hereinafter, embodiments of the present disclosure will be described with reference to the drawings; however, the present disclosure is not limited thereto. Components of the embodiments described below can be combined as appropriate. Meanwhile, some of the components may not be used.

### [Remote Operation System]

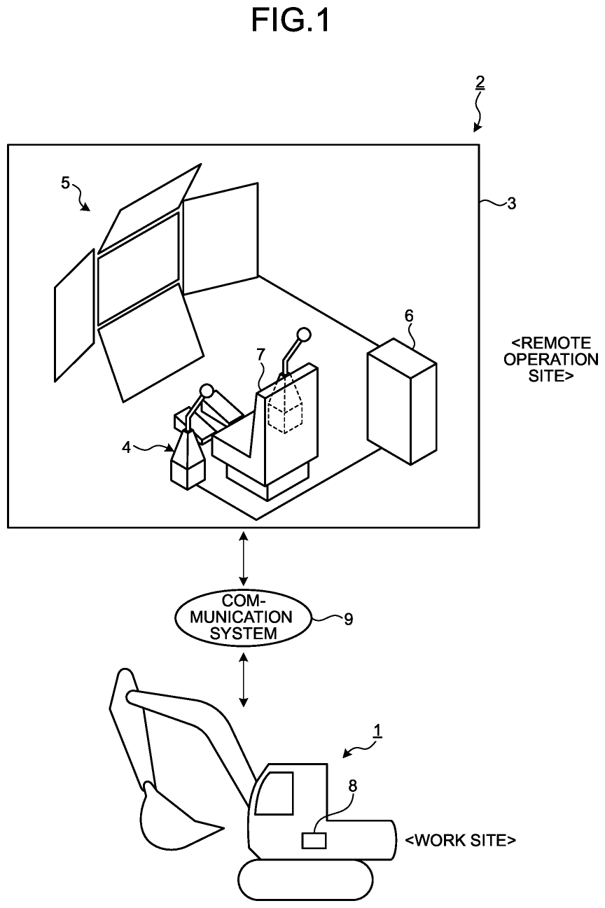

FIG. 1 is a diagram schematically illustrating a remote operation system 2 of a work machine 1 according to an embodiment. The remote operation system 2 remotely operates the work machine 1 present at a work site. At least a part of the remote operation system 2 is disposed in a remote operation room 3 at a remote operation site. The remote operation system 2 includes a remote operation device 4, a display device 5, and a control device 6.

The remote operation device 4 is disposed in the remote operation room 3 external to the work machine 1. The remote operation device 4 is operated by an operator in the remote operation room 3. The operator can operate the remote operation device 4 while seated on an operator's seat 7.

The display device 5 is disposed in the remote operation room 3 external to the work machine 1. The display device 5 displays an image of the work site. The image of the work site includes an image of a predetermined range around the work machine 1. The image of the predetermined range around the work machine 1 includes at least an image of a work target of the work machine 1. The work target of the work machine 1 includes a construction target of the work machine 1.

The display device 5 includes a panel display such as a liquid crystal display (LCD) or an organic electroluminescence display (OELD). In the embodiment, the display device 5 includes a plurality of flat panel displays arranged adjacent to each other. Note that the display device 5 may include one flat panel display. The display device 5 may include a curved display or a screen.

The operator operates the remote operation device 4 while checking the image of the work site displayed on the display device 5. The work machine 1 is remotely operated by the remote operation device 4.

The control device 6 is disposed in the remote operation room 3 external to the work machine 1. The control device 6 includes a computer system.

The work machine 1 includes a control device 8. The control device 8 includes a computer system.

The control device 6 and the control device 8 communicate with each other via a communication system 9. Examples of the communication system 9 include the Internet, a local area network (LAN), a mobile phone communication network, and a satellite communication network.

### [Work Machine]

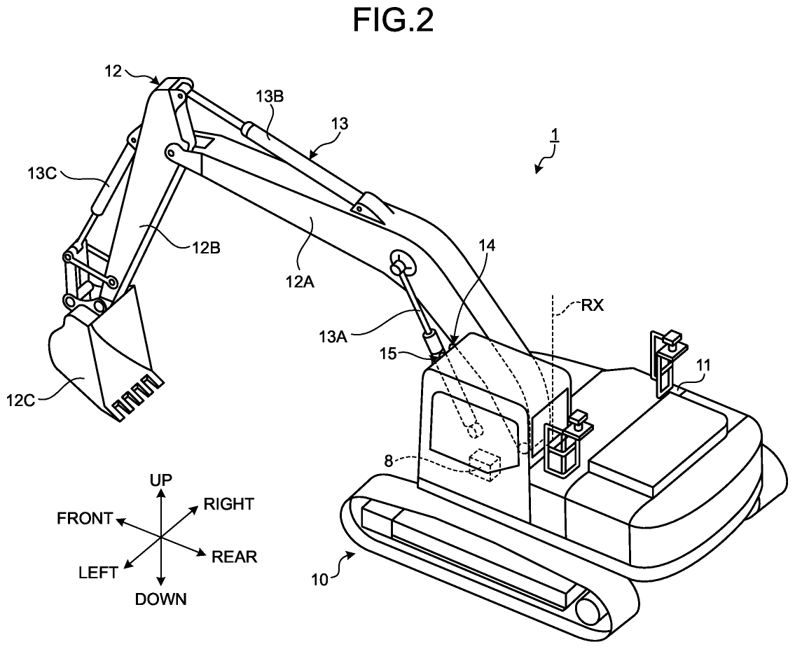

FIG. 2 is a perspective view illustrating a work machine 1 according to the embodiment. In the embodiment, it is based on the premise that the work machine 1 is an excavator. The work machine 1 operates at the work site.

As illustrated in FIG. 2, the work machine 1 includes a traveling body 10, a swing body 11 supported by 30 the traveling body 10, working equipment 12 supported by the swing body 11, a hydraulic cylinder 13 that drives the working equipment 12, a visible light imaging device 14, and an infrared imaging device 15.

The traveling body 10 can travel while supporting the swing body 11. The swing body 11 can turn about a turning axis RX while supported by the traveling body 10. The working equipment 12 includes a boom 12A rotatably coupled to the swing body 11, an arm 12B rotatably coupled to the boom 12A, and a bucket 12C rotatably coupled to the arm 12B. The hydraulic cylinder 13 includes a boom cylinder 13A that drives the boom 12A, an arm cylinder 13B that drives the arm 12B, and a bucket cylinder 13C that drives the bucket 12C.

In the embodiment, a direction parallel to the turning axis RX is referred to as an up-down direction as appropriate, a direction parallel to a rotation axis of the working equipment 12 is referred to as a left-right direction as appropriate, and a direction orthogonal to both the turning axis RX and the rotation axis of the working equipment 12 is referred to as a front-rear direction as appropriate. A direction in which the working equipment 12 is present with respect to the turning axis RX is the forward direction, and the opposite direction of the forward direction is the backward direction. One direction in the left-right direction with respect to the turning axis RX is the rightward direction, and the opposite direction of the rightward direction is the leftward direction. A direction away from the ground contact surface of the traveling body 10 is the upward direction, and a direction opposite to the upward direction is the downward direction.

### [Visible Light Imaging Device and Far-Infrared Imaging Device]

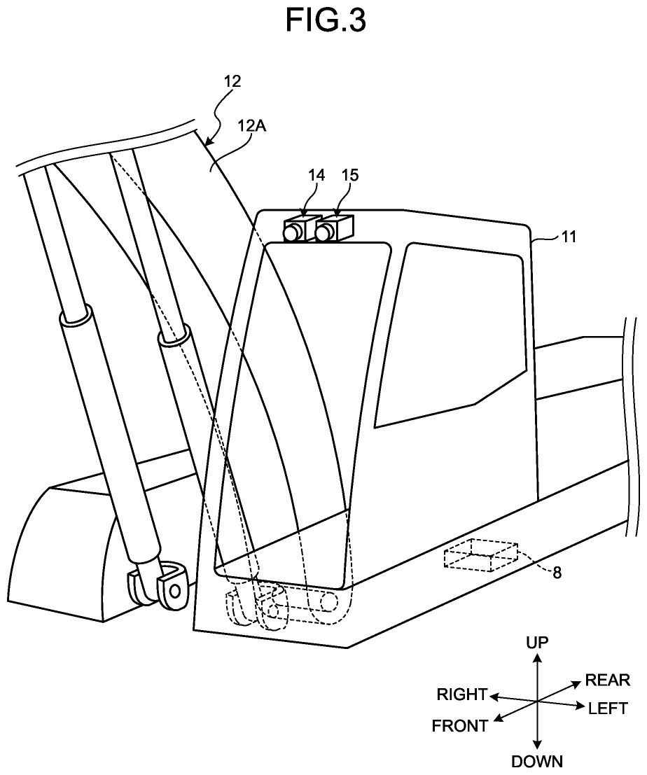

FIG. 3 is a perspective view illustrating the visible light imaging device 14 and the infrared imaging device 15 according to the embodiment. Each of the visible light imaging device 14 and the infrared imaging device 15 is disposed in the work machine 1. In the embodiment, each of the visible light imaging device 14 and the infrared imaging device 15 is disposed on an upper portion of a front portion of the swing body 11. The visible light imaging device 14 and the infrared imaging device 15 simultaneously capture an image of the work site in front of the swing body 11.

The visible light imaging device 14 and the infrared imaging device 15 are arranged in such a manner as to be adjacent to each other in the work machine 1. In the embodiment, the visible light imaging device 14 is arranged on the right side of the infrared imaging device 15. Note that the visible light imaging device 14 may be disposed on the left side of the infrared imaging device 15. Each of the visible light imaging device 14 and the infrared imaging device 15 is fixed to the swing body 11. The relative position between the visible light imaging device 14 and the infrared imaging device 15 is constant.

The visible light imaging device 14 includes a visible light camera that acquires an image of a wavelength range of visible light. The wavelength range of visible light is, for example, 360 [nm] or more and 830 [nm] or less.

The infrared imaging device 15 includes an infrared camera capable of acquiring an image in an infrared spectral range. The infrared spectral range is 780 [nm] or more and 100 [μm] or less. In the embodiment, the infrared imaging device 15 acquires an image of a spectral range of far-infrared rays. The spectral range of the infrared imaging device 15 is, for example, 7.5 [μm] or more and 14 [μm] or less.

Each of the visible light imaging device 14 and the infrared imaging device 15 captures an image of an imaging target present around the work machine 1. The imaging target is an object. Examples of the imaging target to be captured by the visible light imaging device 14 and the infrared imaging device 15 include a construction target of the work machine 1, an excavation target of the working equipment 12, a structure present in the work site, at least a part of the work machine 1, a work machine different from the work machine 1, and a person (worker) working in the work site.

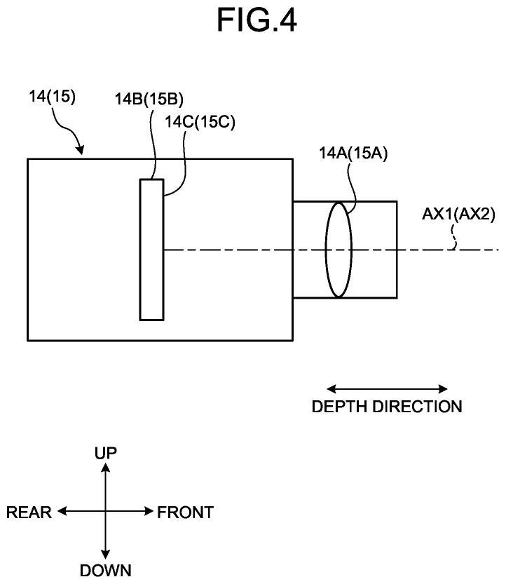

FIG. 4 is a diagram schematically illustrating the visible light imaging device 14 according to the embodiment. The visible light imaging device 14 includes an optical system 14A and an image sensor 14B that receives light having passed through the optical system 14A. Examples of the image sensor 14B include a couple charged device (CCD) image sensor and a complementary metal oxide semiconductor (CMOS) image sensor. An optical axis AX1 of the optical system 14A extends substantially in the front-rear direction. An imaging plane 14C of the image sensor 14B is substantially orthogonal to the optical axis AX1.

Similarly to the visible light imaging device 14, the infrared imaging device 15 includes an optical system 15A and an image sensor 15B. An optical axis AX2 of the optical system 15A extends substantially in the front-rear direction. An imaging plane 15C of the image sensor 15B is substantially orthogonal to the optical axis AX2.

The visible light imaging device 14 and the infrared imaging device 15 are fixed to the work machine 1 in such a manner that the optical axis AX1 and the optical axis AX2 are substantially parallel to each other.

The visible light imaging device 14 captures an image of an imaging target disposed in an imaging range of the visible light imaging device 14. The infrared imaging device 15 captures an image of an imaging target disposed in an imaging range of the infrared imaging device 15. The imaging range of the visible light imaging device 14 coincides with at least a part of the imaging range of the infrared imaging device 15. The imaging range of the visible light imaging device 14 includes a range of vision of the optical system 14A of the visible light imaging device 14. The imaging range of the infrared imaging device 15 includes a range of vision of the optical system 15A of the infrared imaging device 15. In the embodiment, the imaging range of the visible light imaging device 14 coincides with the imaging range of the infrared imaging device 15. Note that the imaging range of the visible light imaging device 14 may coincide with a part of the imaging range of the infrared imaging device 15.

In the following description, an image captured by the visible light imaging device 14 will be referred to as a visible light image Ga as appropriate, and an image captured by the infrared imaging device 15 will be referred to as an infrared image Gb as appropriate.

In the following description, a direction substantially parallel to each of the optical axis AX1 of the visible light imaging device 14 and the optical axis AX2 of the infrared imaging device 15 is referred to as a depth direction as appropriate, and a direction intersecting the optical axis AX1 and the optical axis AX2 is referred to as a screen direction as appropriate.

In the embodiment, it is based on the premise that the screen direction is substantially parallel to each of the imaging plane 14C of the visible light imaging device 14 and the imaging plane 15C of the infrared imaging device 15. The depth direction is equal to the front-rear direction. The screen direction is equal to the left-right direction.

### [Display System]

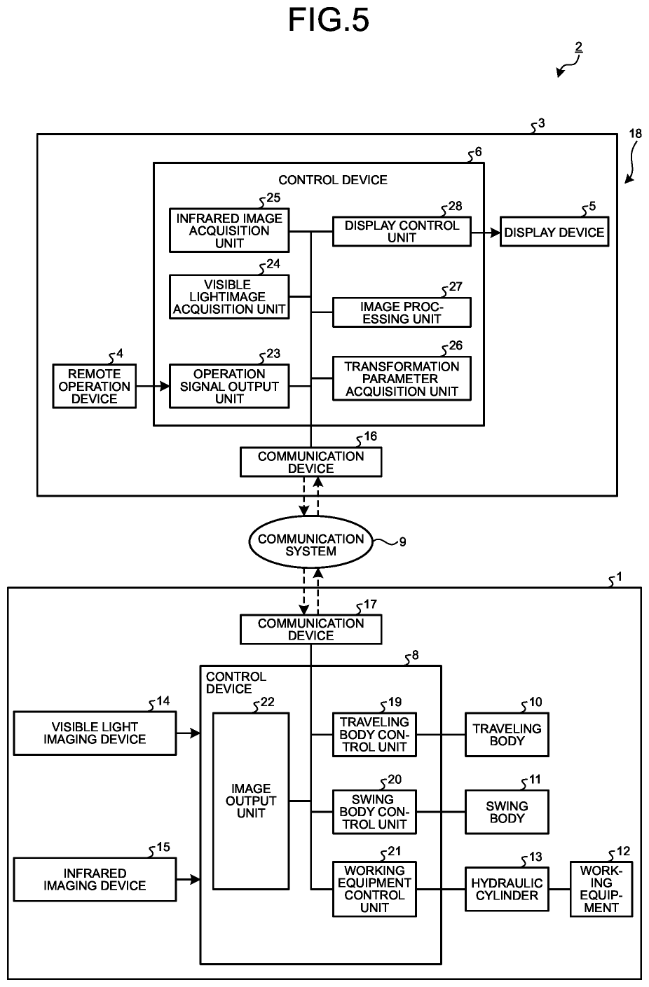

FIG. 5 is a functional block diagram illustrating the remote operation system 2 of the work machine 1 according to the embodiment.

The remote operation system 2 includes a communication device 16 disposed at a remote operation site, the control device 6 connected to the communication device 16, the remote operation device 4 connected to the control device 6, and the display device 5 connected to the control device 6.

The remote operation system 2 further includes a communication device 17 disposed in the work machine 1, the control device 8 connected to the communication device 17, the visible light imaging device 14 connected to the control device 8, the infrared imaging device 15 connected to the control device 8, the traveling body 10 controlled by the control device 8, the swing body 11 controlled by the control device 8, and the hydraulic cylinder 13 controlled by the control device 8.

The remote operation system 2 includes a display system 18 that displays an image of the work site. The display system 18 includes the visible light imaging device 14, the infrared imaging device 15, the control device 6, and the display device 5.

The control device 8 includes a traveling body control unit 19, a swing body control unit 20, a working equipment control unit 21, and an image output unit 22.

The traveling body control unit 19 receives an operation signal of the remote operation device 4 transmitted from the control device 6. The traveling body control unit 19 outputs a control signal for controlling the operation of the traveling body 10 on the basis of the operation signal of the remote operation device 4.

The swing body control unit 20 receives an operation signal of the remote operation device 4 transmitted from the control device 6. The swing body control unit 20 outputs a control signal for controlling the operation of the swing body 11 on the basis of the operation signal of the remote operation device 4.

The working equipment control unit 21 receives an operation signal of the remote operation device 4 transmitted from the control device 6. The working equipment control unit 21 outputs a control signal for controlling the operation of the working equipment 12 on the basis of the operation signal of the remote operation device 4. The control signal for controlling the working equipment 12 includes a control signal for controlling the hydraulic cylinder 13.

The image output unit 22 outputs visible light image data indicating the visible light image Ga captured by the visible light imaging device 14. The image output unit 22 further outputs infrared image data indicating the infrared image Gb captured by the infrared imaging device 15.

The communication device 17 communicates with the communication device 16 via the communication system 9. The communication device 17 receives an operation signal of the remote operation device 4 transmitted from the control device 6 via the communication device 16 and outputs the operation signal to the control device 8. The communication device 17 transmits the visible light image data and the infrared image data output from the image output unit 22 to the communication device 16. The communication device 17 includes an encoder that compresses each of the visible light image data and the infrared image data. Each of the visible light image data and the infrared image data is transmitted from the communication device 17 to the communication device 16 in a compressed state.

The communication device 16 communicates with the communication device 17 via the communication system 9. The communication device 16 transmits an operation signal generated by operation of the remote operation device 4 to the communication device 17. The communication device 16 receives the visible light image data and the infrared image data transmitted from the control device 8 via the communication device 17 and outputs the visible light image data and the infrared image data to the control device 6. The communication device 16 includes a decoder that restores each of the compressed visible light image data and infrared image data. Each of the visible light image data and the infrared image data is output from the communication device 16 to the control device 6 in a restored state.

The control device 6 includes an operation signal output unit 23, a visible light image acquisition unit 24, an infrared image acquisition unit 25, a transformation parameter acquisition unit 26, an image processing unit 27, and a display control unit 28.

The operation signal output unit 23 outputs an operation signal for remotely operating the work machine 1. With the remote operation device 4 operated by the operator, the operation signal for remotely operating the work machine 1 is generated. The operation signal includes an operation signal for remotely operating the traveling body 10, an operation signal for remotely operating the swing body 11, and an operation signal for remotely operating the working equipment 12. The operation signal output unit 23 outputs the operation signal of the remote operation device 4. The communication device 16 transmits the operation signal output from the operation signal output unit 23 to the communication device 17.

The visible light image acquisition unit 24 acquires the visible light image Ga indicating an image of the imaging target captured by the visible light imaging device 14. The visible light image acquisition unit 24 acquires the visible light image Ga by acquiring the visible light image data restored by the communication device 16.

The infrared image acquisition unit 25 acquires the infrared image Gb indicating an image of the imaging target captured by the infrared imaging device 15. The infrared imaging device 15 acquires the infrared image Gb by acquiring the infrared image data restored by the communication device 16.

The transformation parameter acquisition unit 26 acquires a transformation parameter representing transformation of an image. The transformation parameter is determined in advance depending on the situation of the work site. For example, the transformation parameter may be input to the control device 6 via an input device (not illustrated). The transformation parameter acquisition unit 26 may acquire the transformation parameter input from the input device. In the embodiment, the transformation parameter holds a transformation parameter set including a plurality of transformation parameters.

The image processing unit 27 performs image processing on the basis of the visible light image Ga and the infrared image Gb to generate a certain display image. The image processing unit 27 updates the display image at predetermined time intervals.

The display control unit 28 causes the display device 5 to display the display image generated by the image processing unit 27. The operator operates the remote operation device 4 while checking the display image displayed on the display device 5.

### [Outline of Processing of Image Processing Unit]

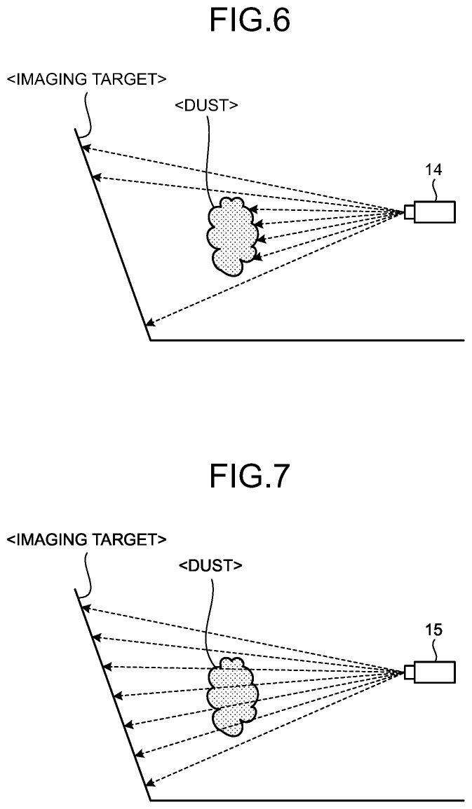

FIG. 6 is a diagram schematically illustrating an example of a state in which the visible light imaging device 14 according to the embodiment is capturing an image of the imaging target. FIG. 7 is a diagram schematically illustrating an example of a state in which the infrared imaging device 15 according to the embodiment is capturing an image of the imaging target.

In the work of the work machine 1, an event may occur in which the visible light image Ga captured by the visible light imaging device 14 is unclear. Examples of the event in which the visible light image Ga is unclear include generation of dust due to the work of the work machine 1. As illustrated in FIGS. 6 and 7, at least a part of the dust may be generated in a space between each of the visible light imaging device 14 and the infrared imaging device 15 and the imaging target.

Visible light cannot be transmitted through the dust. The visible light imaging device 14 cannot capture an image of the imaging target blocked by the dust. The visible light image Ga captured by the visible light imaging device 14 includes the dust and a part of the imaging target.

The infrared ray can be transmitted by dust. The infrared imaging device 15 can capture an image of the imaging target blocked by the dust. The infrared image Gb captured by the infrared imaging device 15 includes almost no dust but includes the entire imaging target.

As described above, in a case where dust is present in the spaces between each of the visible light imaging device 14 and the infrared imaging device 15 and the imaging target, there is a possibility that the entire imaging target is captured in the infrared image Gb, whereas a part of the imaging target is not captured in the visible light image Ga.

The image processing unit 27 performs processing of compensating a part of the visible light image Ga in which the imaging target is not captured with the infrared image Gb.

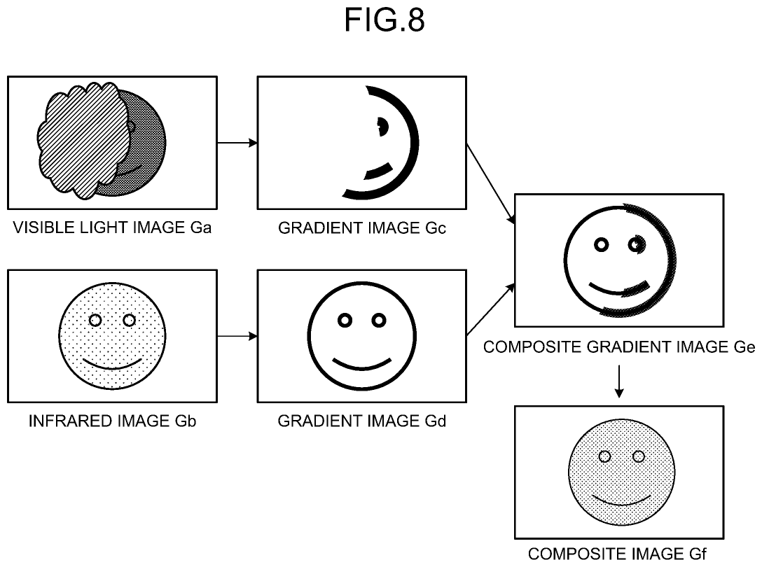

FIG. 8 is a diagram schematically illustrating an outline of processing of the image processing unit 27 according to the embodiment. As illustrated in FIG. 8, a part of the imaging target is not captured in the visible light image Ga, whereas the entire imaging target is captured in the infrared image Gb. The image processing unit 27 generates a gradient image Gc of the visible light image Ga from the visible light image Ga. Furthermore, the image processing unit 27 generates a gradient image Gd of the infrared image Gb from the infrared image Gb. The gradient image Gc includes an image obtained by extracting an edge of the imaging target from the visible light image Ga. The gradient image Gd includes an image obtained by extracting an edge of the imaging target from the infrared image Gb. Since a part of the imaging target is not captured in the visible light image Ga, edges are extracted from the gradient image Gc for the portion where the imaging target is captured, whereas no edge is extracted from the gradient image Gc for the portion where the imaging target is not captured. Since the infrared image Gb captures the entire imaging target, all the edges of the imaging target are extracted from the gradient image Gd. The image processing unit 27 combines the gradient image Gc and the gradient image Gd to generate a composite gradient image Ge. The image processing unit 27 combines color information with the composite gradient image Ge to generate a composite image Gf. As a result, the part of the visible light image Ga in which the imaging target is not captured is compensated by the infrared image Gb, whereby the composite image Gf is generated. The composite image Gf is displayed on the display device 5 as the display image.

A common camera coordinate system is defined for the visible light imaging device 14 and the infrared imaging device 15. The image processing unit 27 combines the gradient image Gc and the gradient image Gd in the camera coordinate system to generate a composite gradient image Ge. Combining the gradient image Gc and the gradient image Gd includes superimposing the gradient image Gc over the gradient image Gd.

Note that the example illustrated in FIG. 8 illustrates an outline of processing of the image processing unit 27 when it is presumed that there is no physical distance between the visible light imaging device 14 and the infrared imaging device 15 and that the optical axis AX1 and the optical axis AX2 coincide with each other. In practice, as described with reference to FIG. 3 and others, the visible light imaging device 14 and the infrared imaging device 15 are arranged apart from each other in the left-right direction.

### [Influence of Parallax]

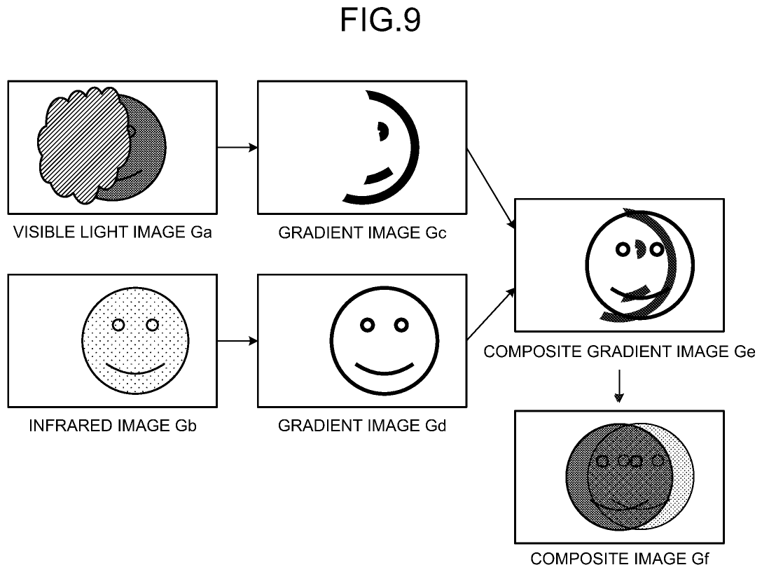

FIG. 9 is a diagram for explaining an influence of parallax between the visible light imaging device 14 and the infrared imaging device 15 on processing of the image processing unit 27. In the embodiment, the visible light imaging device 14 and the infrared imaging device 15 are arranged apart from each other in the left-right direction. Therefore, due to the influence of the parallax between the visible light imaging device 14 and the infrared imaging device 15 with respect to the imaging target, there is a possibility that a ghost edge occurs in the composite image Gf as illustrated in FIG. 9 if the gradient image Gc and the gradient image Gd are only simply combined. That is, there is a possibility that the gradient image Gc and the gradient image Gd are combined in a shifted state due to the influence of the parallax between the visible light imaging device 14 and the infrared imaging device 15 with respect to the imaging target. When the composite image Gf in which the ghost edge is occurring is displayed on the display device 5 as the display image, it is difficult for the operator to recognize the situation of the work site.

Therefore, the image processing unit 27 transforms the gradient image Gd using the transformation parameter to generate a transformation image and then combines the transformation image with the visible light image Ga. As a result, the occurrence of the ghost edge in the composite image Gf is suppressed.

### [Image Processing Unit]

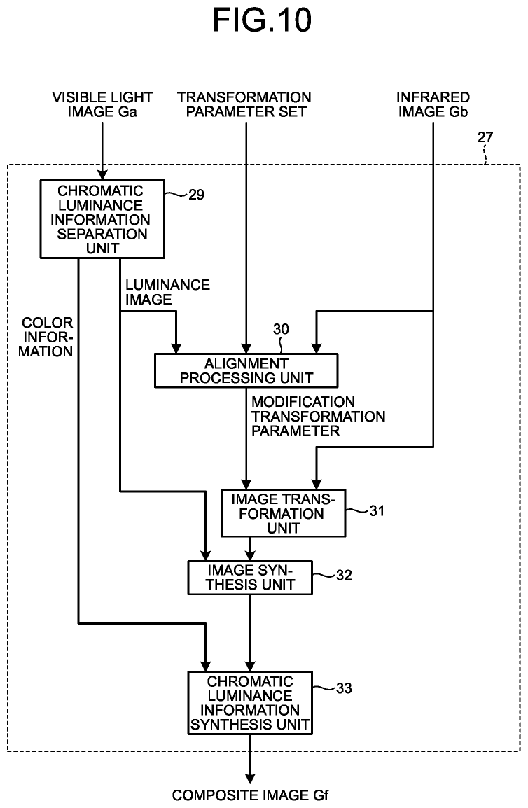

FIG. 10 is a functional block diagram illustrating the image processing unit 27 according to the embodiment. As illustrated in FIG. 10, the image processing unit 27 includes a chromatic luminance information separation unit 29, an alignment processing unit 30, an image transformation unit 31, an image synthesis unit 32, and a chromatic luminance information synthesis unit 33.

The visible light image Ga acquired by the visible light image acquisition unit 24, the infrared image Gb acquired by the infrared image acquisition unit 25, and the transformation parameter set acquired by the transformation parameter acquisition unit 26 are input to the image processing unit 27. The transformation parameter set includes a plurality of transformation parameters representing transformation of an image.

The visible light image Ga is input to the chromatic luminance information separation unit 29. The chromatic luminance information separation unit 29 separates the visible light image Ga into a luminance image and color information (color component image). The luminance image is a gray image.

The luminance image, the infrared image Gb, and the transformation parameter set are input to the alignment processing unit 30. The alignment processing unit 30 outputs a modification transformation parameter.

The modification transformation parameter and the infrared image Gb are input to the image transformation unit 31. The image transformation unit 31 transforms the infrared image Gb on the basis of the modification transformation parameter.

The luminance image and the infrared image Gb transformed by the image transformation unit 31 are input to the image synthesis unit 32 (second synthesis unit). The image synthesis unit 32 combines the luminance image, the infrared image Gb and the luminance image after transformation to generate a composite luminance image. The image synthesis unit 32 combines the luminance image and the infrared image Gb after transformation on the basis of an existing image synthesis method. As the existing image synthesis method, an image synthesis method described in Non Patent Literature 1 is listed as an example.

The composite luminance image and the color information (color component image) are input to the chromatic luminance information synthesis unit 33. The chromatic luminance information synthesis unit 33 combines the composite luminance image and the color information to generate the composite image Gf. The chromatic luminance information synthesis unit 33 combines the composite luminance image and the color information on the basis of an existing image synthesis method. As the existing image synthesis method, an image synthesis method described in Non Patent Literature 1 is listed as an example.

The display control unit 28 causes the display device 5 to display the composite image Gf as the display image.

Note that the infrared image Gb may be any gray image. In a case where the visible light image Ga is a gray image, the chromatic luminance information separation unit 29 and the chromatic luminance information synthesis unit 33 are omitted.

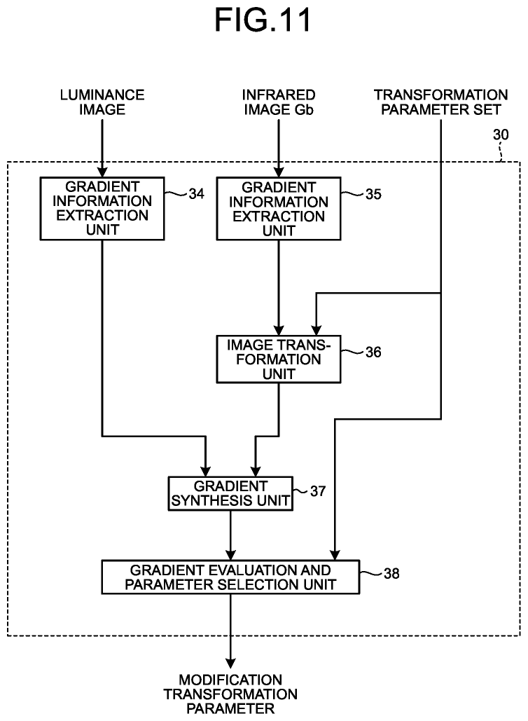

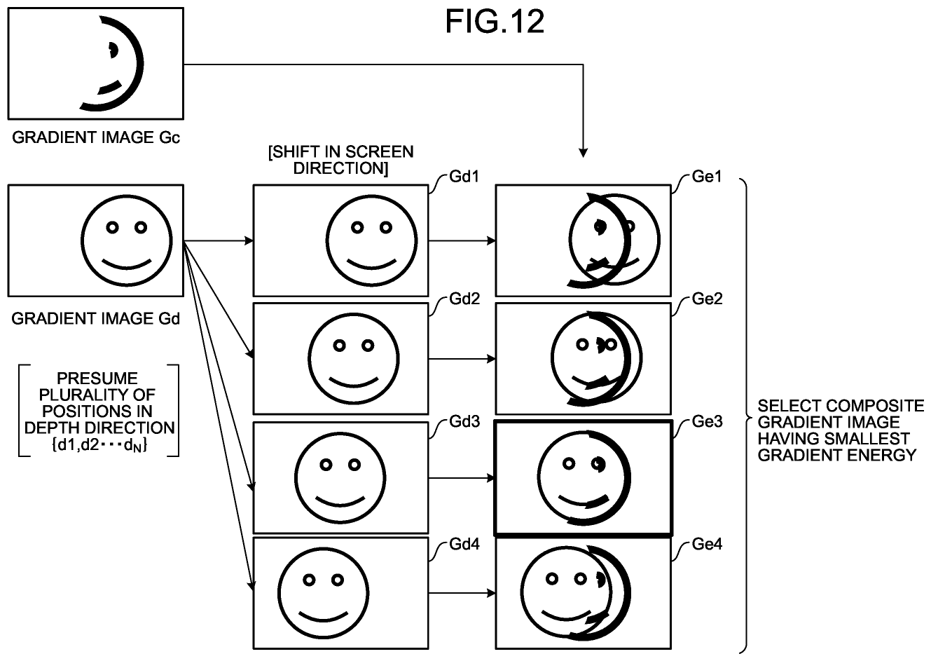

FIG. 11 is a functional block diagram illustrating the alignment processing unit 30 according to the embodiment. FIG. 12 is a diagram schematically illustrating an outline of processing of the alignment processing unit 30 according to the embodiment.

As illustrated in FIG. 11, the alignment processing unit 30 includes a gradient information extraction unit 34, a gradient information extraction unit 35, an image transformation unit 36, a gradient synthesis unit 37, and a gradient evaluation and parameter selection unit 38.

The luminance image, the infrared image Gb, and the transformation parameter set are input to the alignment processing unit 30.

The luminance image is input to the gradient information extraction unit 34. That is, an input image to the gradient information extraction unit 34 is the luminance image. The gradient information extraction unit 34 generates a gradient image Gc of the luminance image. The gradient information extraction unit 34 extracts gradient information for each pixel of the luminance image that is the input image and generates the gradient image Gc of the luminance image.

The input image input to the gradient information extraction unit 34 is represented as u(x, y). (x, y) represents image coordinates. u(x, y) represents a luminance value of the image coordinates (x, y). Furthermore, gradient information of the image coordinate position of (x, y) is denoted as g(x, y). The gradient information g(x, y) is defined by the following Equation (1).

$$g ( x , y ) = \vert L ( u ( x , y ) \vert \qquad ( 1 )$$

In Equation (1), L (.) represents a Laplacian filter. |⋅| denotes an absolute value.

Note that the gradient information g(x, y) may be defined by the following Equation (2).

$$g ( x , y ) = {dx}^{2} ( x , y ) + {dy}^{2} ( x , y ) \qquad ( 2 )$$

In Equation (2), dₓ²(x, y) represents an x-direction difference, and d_{y}²(x, y) represents a y-direction difference. As the differences, a forward difference, a rearward difference, or a central difference is used.

The infrared image Gb is input to the gradient information extraction unit 35. That is, an input image to the gradient information extraction unit 35 is the infrared image Gb. The gradient information extraction unit 35 generates the gradient image Gd of the infrared image Gb. The gradient information extraction unit 35 extracts gradient information for each pixel of the infrared image Gb as the input image and generates the gradient image Gd of the infrared image Gb. Similarly to the gradient information of the luminance image, the gradient information of the infrared image Gb is defined by the above-described Equation (1) or (2).

From the gradient information g(x, y) of the luminance image extracted for each pixel by the gradient information extraction unit 34, the gradient image Gc of the luminance image is generated. The gradient image Gd of the infrared image Gb is generated from the gradient information g(x, y) of the infrared image Gb extracted for each pixel by the gradient information extraction unit 35. The gradient image Gc is an image obtained by extracting edges of the imaging target from the luminance image. The gradient image Gd is an image obtained by extracting edges of the imaging target from the infrared image Gb.

The gradient image Gd of the infrared image Gb and the transformation parameter set are input to the image transformation unit 36. The image transformation unit 36 generates a plurality of transformation gradient images from the gradient image Gd of the infrared image Gb obtained by imaging by the infrared imaging device 15. The image transformation unit 36 transforms the gradient image Gd to generate a transformation gradient image.

In the embodiment, transforming the gradient image Gd includes shifting the gradient image Gd in a predetermined shift direction in the camera coordinate system. The image transformation unit 36 shifts the gradient image Gd in the predetermined shift direction in the camera coordinate system to generate a plurality of transformation gradient images.

In the embodiment, the image transformation unit 36 generates a plurality of transformation gradient images from the gradient image Gd of the infrared image Gb on the basis of the transformation parameter set. That is, the image transformation unit 36 transforms the gradient image Gd on the basis of each of the plurality of transformation parameters to generate a plurality of transformation gradient images. The transformation parameter includes a shift amount in the predetermined shift direction. In the embodiment, the transformation parameter set includes a plurality of shift amounts in the screen direction defined at each of a plurality of positions in the depth direction. A plurality of shift amounts is determined at each of the plurality of positions in the depth direction.

As illustrated in FIG. 12, the image transformation unit 36 presumes a plurality of positions (d1, d2, . . . d_{N}) in the depth direction. The image transformation unit 36 shifts the gradient image Gd at each of a plurality of positions in the screen direction at each of the plurality of positions in the depth direction to generate the plurality of transformation gradient images. The image transformation unit 36 shifts the gradient image Gd in the left-right direction by different shift amounts on the basis of the transformation parameter set. In the example illustrated in FIG. 12, among the plurality of transformation parameters included in the transformation parameter set, a first transformation gradient image Gd1 is generated on the basis of a first transformation parameter, a second transformation gradient image Gd2 is generated on the basis of a second transformation parameter, a third transformation gradient image Gd3 is generated on the basis of a third transformation parameter, and a fourth transformation gradient image Gd4 is generated on the basis of a fourth transformation parameter. Each of the first, second, third, and fourth transformation gradient images Gd1, Gd2, Gd3, and Gd4 has a different shift amount in the left-right direction from the gradient image Gd at a certain position in the depth direction.

Note that the number of transformation gradient images (Gd1, Gd2, Gd3, and Gd4) is not limited to four. There may be two or three transformation gradient images or any number of transformation gradient images more than or equal to five.

The gradient image Gc of the luminance image and the plurality of transformation gradient images Gd1, Gd2, Gd3, and Gd4 are input to the gradient synthesis unit 37. The gradient synthesis unit 37 combines the gradient image Gc of the luminance image and each of the plurality of transformation gradient images Gd1, Gd2, Gd3, and Gd4 in the camera coordinate system to generate a plurality of composite gradient images. As illustrated in FIG. 12, a first composite gradient image Ge1 is generated by combining the gradient image Gc and the first transformation gradient image Gd1. A second composite gradient image Ge2 is generated by combining the gradient image Gc and the second transformation gradient image Gd2. A third composite gradient image Ge3 is generated by combining the gradient image Gc and the third transformation gradient image Gd3. A fourth composite gradient image Ge4 is generated by combining the gradient image Gc and the fourth transformation gradient image Gd4.

Let two gradient images g₁(x, y) and g₂(x, y) be combined. The gradient image after synthesis is denoted by G(x, y). The composite gradient image is expressed by the following Equation (3).

$$G ( x , y ) = \{ \begin{matrix}{g}_{1} ( x , y ) & if {g}_{1} ( x , y ) > {g}_{2} ( x , y ) \\ {g}_{2} ( x , y ) & else\end{matrix} \qquad ( 3 )$$

The transformation parameter set and the plurality of composite gradient images (in the example illustrated in FIG. 12, the first, second, third, and fourth composite gradient images Ge1, Ge2, Ge3, and Ge4) are input to the gradient evaluation and parameter selection unit 38. The gradient evaluation and parameter selection unit 38 evaluates a composite gradient image generated for each transformation parameter. The gradient evaluation and parameter selection unit 38 selects a certain composite gradient image from the plurality of composite gradient images on the basis of an evaluation index. The gradient evaluation and parameter selection unit 38 outputs a transformation parameter that corresponds to a composite gradient image having the best evaluation index as the modification transformation parameter.

The gradient evaluation and parameter selection unit 38 sets a region of interest in the composite gradient image in order to evaluate the gradient. The gradient evaluation and parameter selection unit 38 uses gradient energy indicating a value of the average gradient in the region of interest as the evaluation index of the gradient. The smaller the gradient energy is, the better the evaluation is, and the larger the gradient energy is, the worse the evaluation is. The gradient energy being small means that the ratio of edges in the composite gradient image is small. The gradient energy being large means that the ratio of edges in the composite gradient image is large. In the third composite gradient image Ge3 illustrated in FIG. 12, edges of the gradient image Gc and edges of the third gradient image Gd3 overlap with each other. Therefore, the ratio of the edges in the third composite gradient image Ge3 is small. That is, the third composite gradient image Ge has less ghost edges. Therefore, the gradient energy of the third composite gradient image Ge3 is small, and the evaluation is good. On the other hand, for example, in the first composite gradient image Ge1, the edges of the gradient image Gc are shifted from edges of the first gradient image Gd1. Therefore, the ratio of the edges in the first composite gradient image Ge1 is large. That is, the first composite gradient image Ge1 has many ghost edges. Therefore, the gradient energy of the first composite gradient image Ge1 is large, and the evaluation is poor. The gradient energy of the first composite gradient image Ge1 is large, and the evaluation is poor. Similarly, in the second and fourth composite gradient images Ge2 and G24, the ratio of edges is large. The gradient energies of the second and fourth composite gradient images Ge2 and Ge4 are large, and the evaluation is poor.

In the example illustrated in FIG. 12, the gradient evaluation and parameter selection unit 38 selects the third composite gradient image Ge3 having the smallest gradient energy from the plurality of composite gradient images Ge1, Ge2, Ge3, and Ge4. The gradient evaluation and parameter selection unit 38 outputs the transformation parameter used for generation of the third composite gradient image Ge3 that has been selected, namely, the transformation parameter used for generation of the third transformation gradient image Gd3, as the modification transformation parameter.

Note that, in the example illustrated in FIG. 11, after the gradient image Gd is generated from the infrared image Gb, the transformation gradient image is generated from the gradient image Gd. After the infrared image Gb is transformed to generate a transformed infrared image, gradient information may be extracted from the transformed infrared image to generate the gradient image.

### [Display Method]

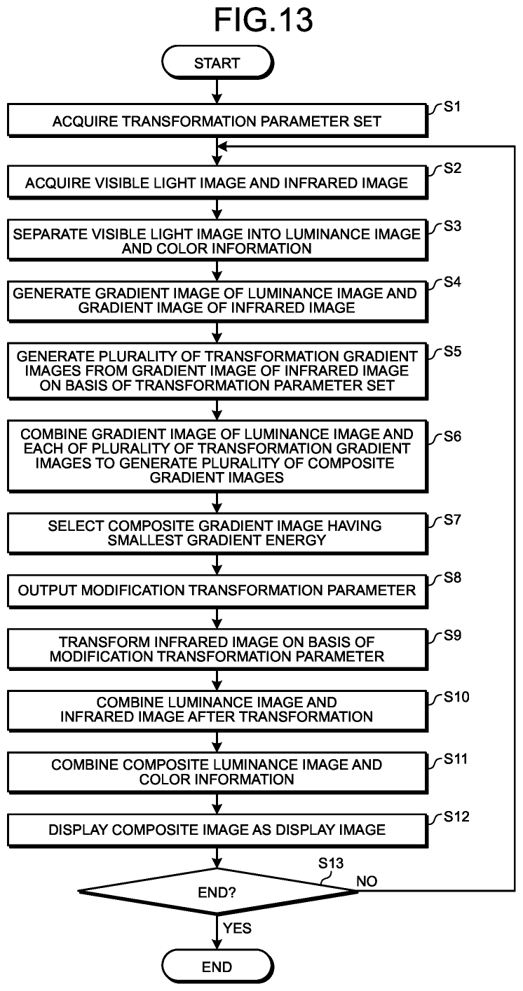

FIG. 13 is a flowchart illustrating a display method according to the embodiment.

The transformation parameter acquisition unit 26 acquires a predetermined transformation parameter set (Step S1).

Each of the visible light imaging device 14 and the infrared imaging device 15 captures an image of the imaging target at the work site. The image output unit 22 transmits the visible light image data indicating the visible light image Ga captured by the visible light imaging device 14 to the control device 6 via the communication device 17 and the communication system 9. The image output unit 22 transmits the infrared image data indicating the infrared image Gb captured by the infrared imaging device 15 to the control device 6 via the communication device 17 and the communication system 9.

The visible light image acquisition unit 24 acquires the visible light image Ga transmitted from the image output unit 22. The infrared image acquisition unit 25 acquires the infrared image Gb transmitted from the image output unit 22 (Step S2).

The chromatic luminance information separation unit 29 separates the visible light image Ga into the luminance image and the color information (Step S3).

The gradient information extraction unit 34 generates a gradient image Gc of the luminance image. The gradient information extraction unit 35 generates the gradient image Gd of the infrared image Gb (Step S4).

The image transformation unit 36 (first transformation unit) generates a plurality of transformation gradient images (first transformation images) from the gradient image Gd (first image) of the infrared image Gb obtained by imaging by the infrared imaging device 15 on the basis of the transformation parameter set. In the example illustrated in FIG. 12, the image transformation unit 36 generates the first, second, third, and fourth transformation gradient images Gd1, Gd2, Gd3, and Gd4 from the gradient image Gd of the infrared image Gb on the basis of the transformation parameter set (Step S5).

The gradient synthesis unit 37 (first synthesis unit) combines the gradient image Gc (second image) of the luminance image obtained by imaging by the visible light imaging device 14 and each of the plurality of transformation gradient images to generate a plurality of composite gradient images (first composite images). In the example illustrated in FIG. 12, the gradient synthesis unit 37 combines the gradient image Gc and each of the first, second, third, and fourth transformation gradient images Gd1, Gd2, Gd3, and Gd4 to generate first, second, third, and fourth composite gradient images Ge1, Ge2, Ge3, and Ge4 (Step S6).

The gradient evaluation and parameter selection unit 38 (selection unit) selects a certain composite gradient image from the plurality of composite gradient images on the basis of the gradient energy that is the evaluation index. The gradient evaluation and parameter selection unit 38 selects a composite gradient image having the smallest gradient energy from the plurality of composite gradient images. In the example illustrated in FIG. 12, the gradient evaluation and parameter selection unit 38 selects the third composite gradient image Ge3 having the smallest gradient energy from among the first, second, third, and fourth composite gradient images Ge1, Ge2, Ge3, and Ge4 (Step S7).

The gradient evaluation and parameter selection unit 38 outputs the transformation parameter used for generation of the composite gradient image selected in Step S7 as the modification transformation parameter. In the example illustrated in FIG. 12, the gradient evaluation and parameter selection unit 38 outputs the transformation parameter used for generation of the third composite gradient image Ge3 as the modification transformation parameter (Step S8).

The image transformation unit 31 (second transformation unit) transforms the infrared image Gb on the basis of the modification transformation parameter to generate the transformed infrared image (second transformation image) (Step S9).

The image synthesis unit 32 (second synthesis unit) combines the transformed infrared image generated in Step S9 and the luminance image (second image) obtained by imaging by the visible light imaging device 14 to generate the composite luminance image (second composite image) (Step S10).

The chromatic luminance information synthesis unit 33 generates the composite luminance image and the color information to generate the composite image Gf (Step S11).

The display control unit 28 causes the display device 5 to display the composite image Gf (second composite image) as the display image (Step S12).

The display control unit 28 determines whether or not to end the display of the display image (Step S13).

If it is determined in Step S13 not to end the display (Step S13: No), the process returns to the processing of Step S2. The processing from Step S2 to Step S12 is performed at a prescribed cycle.

If it is determined in Step S13 to end the display (Step S13: Yes), the display of the display image is ended.

### [Computer System]

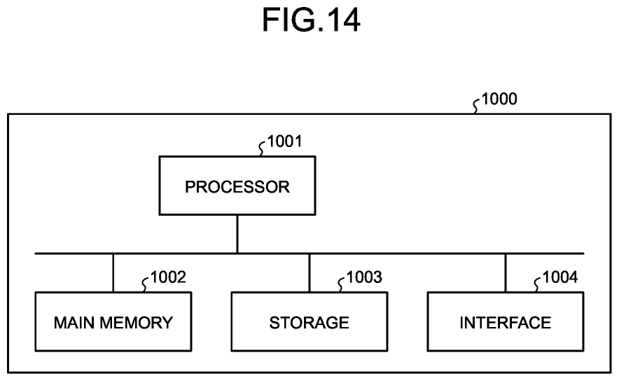

FIG. 14 is a block diagram illustrating a computer system 1000 according to the embodiment. The control device 6 described above includes the computer system 1000. The computer system 1000 includes a processor 1001 such as a central processing unit (CPU), a main memory 1002 including a nonvolatile memory such as a read only memory (ROM) and a volatile memory such as a random access memory (RAM), a storage 1003, and an interface 1004 including an input and output circuit. The functions of the control device 6 described above are stored in the storage 1003 as a computer program. The processor 1001 reads the computer program from the storage 1003, loads the computer program in the main memory 1002, and executes the above-described processing in accordance with the program. Note that the computer program may be distributed to the computer system 1000 via a network.

According to the above-described embodiment, the computer program or the computer system 1000 can execute generation of the plurality of transformation gradient images from the gradient image Gd obtained by imaging by the infrared imaging device 15, generation of the plurality of composite gradient images by combining the gradient image Gc obtained by imaging by the visible light imaging device 14 and each of the plurality of transformation gradient images, selection of a certain composite gradient image from the plurality of composite gradient images on the basis of the gradient energy, and display of the composite image Gf generated on the basis of the selected composite gradient image on the display device 5 as a display image.

### [Effects]

As described above, according to the embodiment, the display system 18 includes the image transformation unit 36 that generates the plurality of gradient transformation images (in the example illustrated in FIG. 12, the first, second, third, and fourth transformation gradient images Gd1, Gd2, Gd3, and Gd4) from the gradient image Gd obtained by imaging by the infrared imaging device 15, the gradient synthesis unit 37 that combines the gradient image Gc obtained by imaging by the visible light imaging device 14 and each of the plurality of gradient transformation images to generate the plurality of composite gradient images (in the example illustrated in FIG. 12, the first, second, third, and fourth composite gradient images Ge1, Ge2, Ge3, and Ge4), the gradient evaluation and parameter selection unit 38 that selects a certain gradient composite image (the third composite gradient image Ge3 in the example illustrated in FIG. 12) from the plurality of composite gradient images on the basis of the gradient energy, and the display control unit 28 that causes the display device 5 to display the display image generated on the basis of the gradient composite image that has been selected. As a result, even when an event occurs in which the visible light image Ga captured by the visible light imaging device 14 is unclear, the unclear portion of the visible light image Ga is compensated by the infrared image Gb, and occurrence of a ghost edge in the display image is suppressed. Even when an event occurs in which the composite image of the visible light image Ga and the infrared image Gb is unclear, the display system 18 can appropriately provide the operator of the work machine 1 with the situation around the work machine 1.

The image transformation unit 36 shifts the gradient image Gd in a predetermined shift direction (left-right direction in the embodiment) to generate the plurality of gradient transformation images. Due to the influence of the parallax between the visible light imaging device 14 and the infrared imaging device 15 with respect to the imaging target, there is a possibility that a ghost edge occurs in the composite image Gf if the gradient image Gc and the gradient image Gd are only simply combined. In the embodiment, since the gradient image Gd shifted in the predetermined shift direction and the gradient image Gc are combined, occurrence of a ghost edge is suppressed.

The image transformation unit 36 generates the plurality of gradient transformation images from the gradient image Gd on the basis of the transformation parameter set including the plurality of transformation parameters. The transformation parameter set is determined in advance in accordance with the situation of the work site. A transformation parameter includes a shift amount of the gradient image Gd in the predetermined shift direction. The image transformation unit 36 can efficiently generate the plurality of gradient transformation images from the gradient image Gd on the basis of the transformation parameter set.

As described with reference to FIG. 12, in the embodiment, in a case where the composite gradient images are generated, the position of the gradient image Gc generated from the visible light image Ga is fixed, and the gradient image Gd generated from the infrared image Gb is shifted in the screen direction. In a case where there occurs no event of the visible light image Ga being unclear, the visible light image Ga is displayed on the display device 5, and the operator operates the remote operation device 4 while confirming the visible light image Ga. In a case where there occurs an event of the visible light image Ga being unclear, when the gradient image Gc generated from the visible light image Ga is shifted in the screen direction, there is a possibility that the position of the visible light image Ga in the display device 5 is shifted between a case where there occurs no event of the visible light image Ga being unclear and a case where the event occurs. When the position of the visible light image Ga is shifted, the operator may feel uncomfortable. With the position of the gradient image Gc generated from the visible light image Ga fixed and the gradient image Gd generated from the infrared image Gb shifted in the screen direction, it is possible to suppress the position of the visible light image Ga on the display device 5 from being shifted between the case where there occurs no event of the visible light image Ga being unclear and the case where the event occurs.

### OTHER EMBODIMENTS

As described with reference to FIG. 12, in the embodiment described above, in the case where the composite gradient images are generated, the position of the gradient image Gc generated from the visible light image Ga is fixed, and the gradient image Gd generated from the infrared image Gb is shifted in the screen direction. The position of the gradient image Gd generated from the infrared image Gb may be fixed, and the gradient image Gc generated from the visible light image Ga may be shifted in the screen direction. Alternatively, both the gradient image Gc and the gradient image Gd may be shifted in the screen direction.

In the above-described embodiment, the visible light imaging device 14 and the infrared imaging device 15 are arranged in the left-right direction. The visible light imaging device 14 and the infrared imaging device 15 may be arranged in the up-down direction. In Step S5 illustrated in FIG. 13, the image transformation unit 36 may shift the gradient image Gd in the up-down direction.

In the above-described embodiment, when the gradient evaluation and parameter selection unit 38 selects a certain composite gradient image Ge from the plurality of composite gradient images Ge, the gradient energy is used as the evaluation index. The gradient evaluation and parameter selection unit 38 may select a composite gradient image Ge having the smallest gradient energy in the entire captured image. Note that the gradient evaluation and parameter selection unit 38 may generate a composite gradient image Ge having small gradient energy in, for example, a region of an image desirably selected by the operator on the display image, and display the periphery of the region of the selected image most clearly (without image shift).

In the embodiment described above, the event in which the image captured by the visible light imaging device 14 is unclear is occurrence of dust. Examples of the event in which the image captured by the visible light imaging device 14 is unclear include, in addition to generation of dust, generation of fog, an insufficient amount of visible light due to work of the work machine being performed at night, and the imaging target being in a backlight state.

In a case where fog particles (water droplets) are present in the spaces between the visible light imaging device 14 and the infrared imaging device 15 and the imaging target, it is difficult for visible light to be transmitted through the fog particles, whereas infrared rays can be transmitted through the fog particles. Therefore, the display system 18 can generate the composite image Gf according to the above embodiment. Even when an event occurs in which at least a part of the visible light image Ga captured by the visible light imaging device 14 is unclear, the display system 18 can provide the operator of the work machine 1 with the situation around the work machine 1 by displaying the composite image Gf on the display device 5.

In the above embodiment, the display system 18 is applied to the remote operation system 2. The display device 5 may not be disposed in the remote operation room 3. The display device 5 may be disposed in an operation room (cab) of the work machine 1. In addition, some functions of the control device 6 described in the embodiment may be arranged in the work machine 1. The operator onboard in the operation room of the work machine 1 can operate a boarding operation device disposed in the operation room of the work machine 1 while confirming the display device 5 disposed in the operation room of the work machine 1. Even in this case, the display system 18 can provide the operator of the work machine 1 with the situation around the work machine 1 even when an event occurs in which the visible light image Ga captured by the visible light imaging device 14 is unclear.

In the embodiment, it is based on the premise that the work machine 1 is an excavator. The work machine 1 may be a bulldozer, a wheel loader, or a dump truck. In a case where the work machine 1 is, for example, a dump truck, an image in the traveling direction of the work machine 1 may be displayed on the display device 5 in addition to the image of the surroundings of the work machine 1 as images of the work site.

### REFERENCE SIGNS LIST

1 WORK MACHINE
2 REMOTE OPERATION SYSTEM
3 REMOTE OPERATION ROOM
4 REMOTE OPERATION DEVICE
5 DISPLAY DEVICE
6 CONTROL DEVICE
7 OPERATOR'S SEAT
8 CONTROL DEVICE
9 COMMUNICATION SYSTEM
10 TRAVELING BODY
11 SWING BODY
12 WORKING EQUIPMENT
12A BOOM
12B ARM
12C BUCKET
13 HYDRAULIC CYLINDER
13A BOOM CYLINDER
13B ARM CYLINDER
13C BUCKET CYLINDER
14 VISIBLE LIGHT IMAGING DEVICE
14A OPTICAL SYSTEM
14B IMAGE SENSOR
14C IMAGING PLANE
15 INFRARED IMAGING DEVICE
15A OPTICAL SYSTEM
15B IMAGE SENSOR
15C IMAGING PLANE
16 COMMUNICATION DEVICE
17 COMMUNICATION DEVICE
18 DISPLAY SYSTEM
19 TRAVELING BODY CONTROL UNIT
20 SWING BODY CONTROL UNIT
21 WORKING EQUIPMENT CONTROL UNIT
22 IMAGE OUTPUT UNIT
23 OPERATION SIGNAL OUTPUT UNIT
24 VISIBLE LIGHT IMAGE ACQUISITION UNIT
25 INFRARED IMAGE ACQUISITION UNIT
26 TRANSFORMATION PARAMETER ACQUISITION UNIT
27 IMAGE PROCESSING UNIT
28 DISPLAY CONTROL UNIT
29 CHROMATIC LUMINANCE INFORMATION SEPARATION UNIT
30 ALIGNMENT PROCESSING UNIT
31 IMAGE TRANSFORMATION UNIT
32 IMAGE SYNTHESIS UNIT
33 CHROMATIC LUMINANCE INFORMATION SYNTHESIS UNIT
34 GRADIENT INFORMATION EXTRACTION UNIT
35 GRADIENT INFORMATION EXTRACTION UNIT
36 IMAGE TRANSFORMATION UNIT
37 GRADIENT SYNTHESIS UNIT
38 GRADIENT EVALUATION AND PARAMETER SELECTION UNIT
1000 COMPUTER SYSTEM
1001 PROCESSOR
1002 MAIN MEMORY
1003 STORAGE
1004 INTERFACE
Ga VISIBLE LIGHT IMAGE
Gb INFRARED IMAGE
Gc GRADIENT IMAGE
Gd GRADIENT IMAGE
Ge COMPOSITE GRADIENT IMAGE
Gf COMPOSITE IMAGE
AX1 OPTICAL AXIS
AX2 OPTICAL AXIS
RX TURNING AXIS.

1. A display system comprising:
a first transformation unit that generates a plurality of first transformation images from a first image obtained by imaging by a first imaging device;
a first synthesis unit that combines a second image obtained by imaging by a second imaging device and each of a plurality of the first transformation images to generate a plurality of first composite images;
a selection unit that selects a certain first composite image from the plurality of first composite images; and
a display control unit that causes a display device to display a display image generated on a basis of the first composite image that has been selected.

2. The display system according to claim 1,
wherein the first transformation unit shifts the first image in a predetermined shift direction to generate the plurality of first transformation images.

3. The display system according to claim 1 or 2,
wherein the first transformation unit generates a plurality of the first transformation images by shifting the first image to each of a plurality of positions in a screen direction intersecting an optical axis of the first imaging device at each of a plurality of positions in a depth direction parallel to the optical axis.

4. The display system according to any one of claims 1 to 3,
wherein the first transformation unit transforms the first image on a basis of each of a plurality of transformation parameters to generate a plurality of the first transformation images.

5. The display system according to claim 4,
wherein the selection unit outputs the transformation parameter used for generation of the first composite image that has been selected as a modification transformation parameter,
the display system further comprising:
a second transformation unit that transforms the first image on a basis of the modification transformation parameter to generate a second transformation image; and
a second synthesis unit that combines the second transformation image and the second image to generate a second composite image, and
the display image includes the second composite image.

6. The display system according to any one of claims 1 to 5,
wherein the first imaging device is an infrared imaging device, and
the second imaging device is a visible light imaging device.

7. The display system according to any one of claims 1 to 6,
wherein the first imaging device and the second imaging device are arranged in such a manner as to be adjacent to each other in a work machine.

8. A display method comprising:
generating a plurality of first transformation images from a first image obtained by imaging by a first imaging device;
combining a second image obtained by imaging by a second imaging device and each of a plurality of the first transformation images to generate a plurality of first composite images;
selecting a certain first composite image from a plurality of the first composite images; and
causing a display device to display a display image generated on a basis of the first composite image that has been selected.
